(19) United States
(12) Patent Application Publication
(10) Pub. No.: US 2024/0367280 A1
(43) Pub. Date: Nov. 7, 2024

(54) RANDOM ORBIT SANDER

(71) Applicant: MILWAUKEE ELECTRIC TOOL CORPORATION, Brookfield, WI (US)

(72) Inventors: Tanner Vaculik, Brown Deer, WI (US); Kyle W. Schultz, Mequon, WI (US); Peter A. Borowski, Milwaukee, WI (US); Joseph J. Drees, Wauwatosa, WI (US); Trevor L. Paff, Slinger, WI (US); Taite A. Kurzka Chughtai, Waukesha, WI (US); Cheng Yuan, Chicago, IL (US); Jonathan E. Wojtalik, Mt. Prospect, IL (US)

(21) Appl. No.: 18/648,773

(22) Filed: Apr. 29, 2024

Related U.S. Application Data
(60) Provisional application No. 63/464,395, filed on May 5, 2023.

(51) Int. Cl. B24B 23/03; B24B 23/02; B25F 5/00

(52) U.S. Cl. CPC B24B 23/03; B24B 23/022; B25F 5/006

(57) ABSTRACT

A random orbit sander includes a housing having a motor housing portion and a handle portion extending from the motor housing portion, a motor disposed within the motor housing portion, a random orbit mechanism driven by the motor and having an output shaft, a backing pad removably engaged with the output shaft; and a spindle lock assembly adjacent the backing pad, wherein the spindle lock assembly includes a support ring and a wrench rotatably disposed on the support ring between a stowed position, in which the wrench is disengaged from a nut on the output shaft, and a deployed position, in which the wrench is engaged with the nut to lock rotation of the output shaft.

### CROSS-REFERENCE TO RELATED APPLICATIONS

This application claims priority to co-pending U.S. Provisional Patent Application No. 63/464,395 filed on May 5, 2023, the entire content of which is incorporated herein by reference.

### FIELD OF THE INVENTION

The present invention relates to random orbit sanders.

### BACKGROUND OF THE INVENTION

Random orbit sanders are used to smooth workpieces that include wood, metal, etc. Improvements in these tools are always sought after in the industry.

### SUMMARY OF THE INVENTION

The present invention provides, in one aspect, a random orbit sander that includes a housing having a motor housing portion and a handle portion extending from the motor housing portion, a motor disposed within the motor housing portion, a random orbit mechanism driven by the motor and having an output shaft, a backing pad removably engaged with the output shaft; and a spindle lock assembly adjacent the backing pad, wherein the spindle lock assembly includes a support ring and a wrench rotatably disposed on the support ring between a stowed position, in which the wrench is disengaged from a nut on the output shaft, and a deployed position, in which the wrench is engaged with the nut to lock rotation of the output shaft.

The present invention provides, in one aspect, a random orbit sander that includes a housing having a motor housing portion and a handle portion extending from the motor housing portion, a motor disposed within the motor housing portion, a random orbit mechanism driven by the motor and having an output shaft, a backing pad removably engaged with the output shaft, a fan configured to rotate with the motor, and a fan shroud formed around the fan, wherein the fan shroud includes a variable radius R as measured from a center of the fan, wherein the variable radius R changes from a first end of the fan shroud to a second end of the fan shroud.

The present invention provides, in another aspect, a random orbit sander that includes a housing having a motor housing portion and a handle portion extending from the motor housing portion, a motor disposed within the motor housing portion, a random orbit mechanism driven by the motor and having an attachment nut, a spindle threadably engaged with the attachment nut, and a backing pad removably engaged with the spindle.

The present invention provides, in still another aspect, a random orbit sander that includes a housing having a motor housing portion and a handle portion extending from the motor housing portion, a motor disposed within the motor housing portion, a random orbit mechanism driven by the motor and having an output shaft, a backing pad removably engaged with the output shaft, a dust outlet, one or more universal vacuum attachment mounts adjacent the dust outlet, a first vacuum attachment installable on the one or more universal vacuum attachment mounts, and a second vacuum attachment installable the one or more universal vacuum attachment mounts, second vacuum attachment is different from the first vacuum attachment.

The present invention provides, in yet another aspect, a random orbit sander that includes a housing having a motor housing portion and a handle portion extending from the motor housing portion, wherein the housing includes a first housing shell coupled to a second housing shell along a first seam; a motor disposed within the motor housing portion; a random orbit mechanism driven by the motor and having an output shaft; a backing pad removably engaged with the output shaft; and a battery receptacle disposed within the housing, the battery receptacle including a first receptacle shell attached to a second receptacle shell along a second seam, wherein the second seam is formed at an angle with respect to the first seam.

The present invention provides, in one aspect, a random orbit sander that includes a housing having a motor housing portion and a handle portion extending from the motor housing portion, a motor disposed within the motor housing portion, a random orbit mechanism driven by the motor and having an output shaft, a backing pad removably engaged with the output shaft, a mode switch located on the housing, a paddle switch located on the housing proximate the mode switch, and an electronic control unit in communication with the mode switch and the paddle switch to receive input therefrom, the electronic control unit also in communication with the motor to control operation thereof in response to input from the mode switch and the paddle switch, wherein the electronic control unit is operable to control the motor in a standard operating mode, in which the motor is operable at a variable speed by the paddle switch, in response to the mode switch being pressed and released, and wherein the electronic control unit is operable to control the motor in a lock-on operating mode, in which the motor is indefinitely operable at a fixed speed, in response to the mode switch being pressed and held for a predetermined time period.

Other features and aspects of the invention will become apparent by consideration of the following detailed description and accompanying drawings.

### BRIEF DESCRIPTION OF THE DRAWINGS

FIG. 1 is a perspective view of a random orbit sander in accordance with an embodiment of the invention.

FIG. 2 is a front view of the random orbit sander of FIG. 1.

FIG. 3 is a side view of the random orbit sander of FIG. 1.

FIG. 4 is a top view of the random orbit sander of FIG. 1.

FIG. 5 is a side view of the random orbit sander of FIG. 1 with a portion of the housing removed.

FIG. 6 is a detail view of the random orbit sander of FIG. 1 taken at Box 6 in FIG. 5 with a portion of a switch housing shown in cross-section.

FIG. 7 is a detailed view of a paddle switch for the random orbit sander of FIG. 1 with a portion of the switch housing shown in cross-section.

FIG. 8 is a rear perspective view of the random orbit sander of FIG. 1.

FIG. 9 is a cross section view of the random orbit sander of FIG. 1 taken along Line 9-9 of FIG. 3.

FIG. 10 is a side view of the random orbit sander of FIG. 1 with a portion of the housing and the battery receptacle removed.

FIG. 11 is a perspective view of a battery receptacle of the random orbit sander of FIG. 1.

FIG. 12 is a top view of the battery receptacle of FIG. 11.

FIG. 13 is an end view of the battery receptacle of FIG. 11.

FIG. 14 is a cross section view of the random orbit sander of FIG. 1 taken along Line 14-14 in FIG. 3.

FIG. 15 is a perspective view of a spindle lock assembly of the random orbit sander of FIG. 1 in a stowed position.

FIG. 16 is an exploded perspective view of the spindle lock assembly of FIG. 15.

FIG. 17 is a side view of the spindle lock assembly of FIG. 15.

FIG. 18 is a top view of the spindle lock assembly of FIG. 15 in the stowed position.

FIG. 19 is a top view of the spindle lock assembly of FIG. 15 in the deployed position.

FIG. 20 is a perspective view of another embodiment of a spindle lock assembly in a stowed position.

FIG. 21 is a perspective view of the spindle lock assembly of FIG. 20 in a deployed position.

FIG. 22 is a perspective view of yet another embodiment of a spindle lock assembly in a stowed position.

FIG. 23 is a perspective view of a backing pad for the random orbit sander of FIG. 1 in a locked position.

FIG. 24 is a cross-section view of the backing pad of FIG. 19.

FIG. 25 is a perspective view of the backing pad of FIG. 19 in a released position.

FIG. 26 is a perspective view of a support post of the backing pad of FIG. 19.

FIG. 27 is a rear plan view of another random orbit sander.

FIG. 28 is a top plan view of the random orbit sander of FIG. 27.

FIG. 29 is a top plan view of the random orbit sander of FIG. 27.

FIG. 30 is a plan view of a vacuum attachment of the random orbit sander of FIG. 27.

FIG. 31 is a perspective view of still another random orbit sander.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

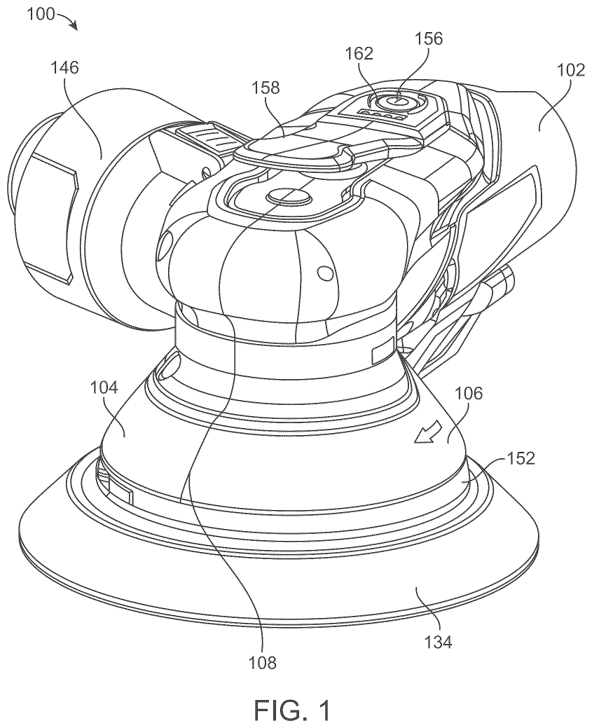

Referring to FIGS. 1-10, a random orbit sander 100 is illustrated. The random orbit sander 100 includes a housing 102 having a first housing shell 104 joined to a second housing shell 106 along a seam 108. Further, the housing 102 includes a motor housing portion 110 extending along a motor axis 112. A handle portion 114 extends from the motor housing portion 110 along a handle axis 116. In a particular aspect, the handle axis 116 is perpendicular to the motor axis 112. Further, the handle axis 116 is co-linear with a longitudinal axis of the random orbit sander 100. The random orbit sander 100 further includes a battery receptacle 118 within the handle portion 114. The battery receptacle 118 is sandwiched, or otherwise held, between the first housing shell 104 and the second housing shell 106. The battery receptacle 118 is sized and shaped to receive a removable battery pack therein.

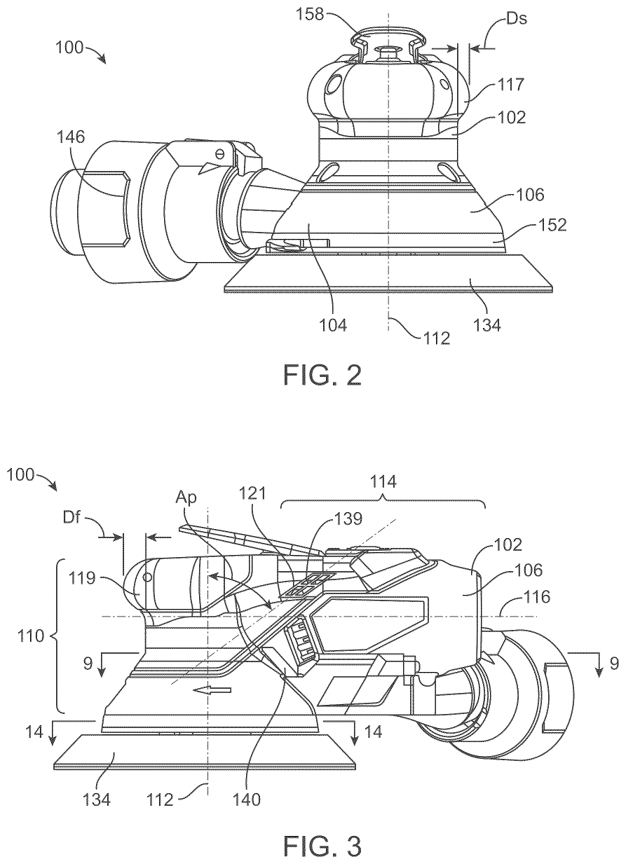

FIG. 2 shows that the housing 102 includes a side overhang 117 and FIG. 3 shows that the housing 102 includes a front overhang 119. The overhangs 117, 119 include specific geometries that provide for an ergonomic grip and improve the user experience with the random orbit sander 100. Specifically, the side overhang 117 has a depth Ds and the front overhang 119 has a depth Df. In a particular aspect, Ds is less than Df. For example, Ds is less than or equal to 0.600 Df, such as less than or equal to 0.575 Df, less than or equal to 0.550 Df, less than or equal to 0.525 Df, or less than or equal to 0.500 Df. In another aspect, Ds is greater than or equal to 0.350 Df, such as greater than or equal to 0.375 Df, greater than or equal to 0.400 Df, greater than or equal to 0.425 Df, or greater than or equal to 0.450 Df. In another aspect, Ds is equal to 0.455 Df. It is to be understood that Ds can be within a range between, and including, any of the maximum and minimum values of Ds described herein.

In another aspect, Ds is less than or equal to 7.00 mm, such as less than or equal to 6.75 mm, less than or equal to 6.50 mm, less than or equal to 6.25 mm, less than or equal to 6.00 mm, less than or equal to 5.75 mm, less than or equal to 5.50 mm, or less than or equal to 5.25 mm. Ds is greater than or equal to 4.00 mm, such as greater than or equal to 4.25 mm, greater than or equal to 4.50 mm, or greater than or equal to 4.75 mm. In another aspect, Ds is equal to 5.00 mm. It is to be understood that Ds can be within a range between, and including, any of the maximum and minimum values of Ds described herein.

In yet another aspect, Df is less than or equal to 13.00 mm, such as less than or equal to 12.75 mm, less than or equal to 12.50 mm, less than or equal to 12.25 mm, less than or equal to 12.00 mm, less than or equal to 11.75 mm, less than or equal to 11.50 mm, or less than or equal to 11.25 mm. Df is greater than or equal to 10.00 mm, such as greater than or equal to 10.25 mm, greater than or equal to 10.50 mm, or greater than or equal to 10.75 mm. In another aspect, Df is equal to 11.00 mm. It is to be understood that Df can be within a range between, and including, any of the maximum and minimum values of Df described herein.

FIG. 3 further indicates that the housing 102 includes a thumb pocket 121 formed in the second housing shell 106. The thumb pocket 121 extends in a generally downward and forward direction from the top of the housing 102. The thumb pocket 121 forms a pocket angle Ap with respect to the motor axis 112. In a particular aspect, the pocket angle Ap is greater than or equal to 34.00 degrees. For example, the pocket angle Ap is greater than or equal to 34.25 degrees, such as greater than or equal to 34.50 degrees, greater than or equal to 34.75 degrees, greater than or equal to 35.00 degrees, greater than or equal to 35.25 degrees, greater than or equal to 35.50 degrees, greater than or equal to 35.75 degrees, or greater than or equal to 36.00 degrees. In another aspect, the pocket angle Ap is less than or equal to 38.00 degrees, such as less than or equal to 38.75 degrees, less than or equal to 38.50 degrees, less than or equal to 38.25 degrees, less than or equal to 38.00 degrees, less than or equal to 37.25 degrees, less than or equal to 37.00 degrees, less than or equal to 36.75 degrees, or less than or equal to 36.50 degrees. In another aspect, the pocket angle Ap is equal to 36.25 degrees. It is to be understood that the pocket angle Ap can be within a range between, and including, any of the minimum and maximum values of Ap described herein. It is to be further understood that the first housing shell 104 includes a thumb pocket that is substantially identical to the thumb pocket 121 formed in the second housing shell 106. Also, it is to be understood that the thumb pocket in the first housing shell 104 is aligned with the thumb pocket 121 in the second housing shell 106. As such, the random orbit sander 100 is ergonomically comfortable for left-handed and right-handed users.

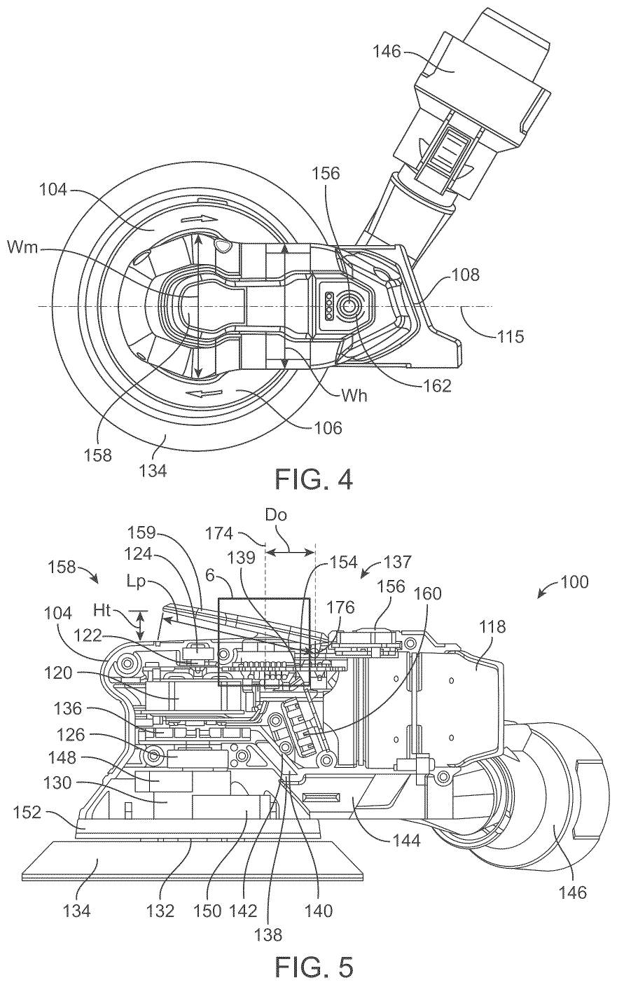

FIG. 4 shows that the motor housing portion 110 includes an overall width Wm measured at the widest portion of the motor housing portion 110 perpendicular to the longitudinal axis 123. Moreover, the handle portion 114 includes an overall handle width Wh measured at the widest portion of the handle portion 114 perpendicular to the longitudinal axis 123. In a particular aspect, Wh is less than Wm. For example, Wh is less than or equal to 0.950 Wm, such as less than or equal to 0.925 Wm or less than or equal to 0.900 Wm. In another aspect, Wh is greater than or equal to 0.750 Wm, such as greater than or equal to 0.775 Wm, greater than or equal to 0.800 Wm, greater than or equal to 0.825 Wm, or greater than or equal to 0.850 Wm. In another particular aspect, Wh is equal to 0.875 Wm. It is to be understood that Wh may be within a range between, and including, any of the maximum or minimum values of Wh described herein.

As shown in FIG. 5, the motor housing portion 110 includes a motor 120 disposed therein. For example, the motor 120 is a brushless direct current (BLDC) motor that receives power from a battery pack that is engaged with the battery receptacle 118. The motor 120 includes a motor shaft 122 that rotates on a first bearing 124 and a second bearing 126. The motor shaft 122 drives a random orbit mechanism 130 that includes an output shaft 132. A backing pad 134 is removably attached to the output shaft 132 of the random orbit mechanism 130. Specifically, the backing pad 134 is threadably engaged with an attachment nut 280, described below, that is pressed into a bearing within a counterweight 150. FIG. 3 further shows a fan 136 that is disposed on the motor shaft 122 above the second bearing 126. The fan 136 rotates with the motor shaft 122 to induce an airflow through the housing 102 to cool the motor 120 and an onboard electronic control unit 137 of the random orbit sander 100 during operation. An intake duct 139 is formed in each of the housing shells 104, 106 to allow air to enter the random orbit sander 100. Moreover, is formed in each of the housing shells 104, 106 to provide air exit channels for the air flow generated by the fan 136. An internal housing wall 142 separates the exhaust ducts 138 from the internal components of the random orbit sander 100 (e.g., the controller, etc.).

Each exhaust duct 138 terminates in an exhaust outlet 140 that is that is perpendicular to the exhaust ducts 138. Each exhaust outlet 140 includes an opening area A that is greater than or equal to 180 mm², such as greater than or equal to 185 mm², greater than or equal to 190 mm², greater than or equal to 195 mm², greater than or equal to 200 mm², greater than or equal to 205 mm², greater than or equal to 210 mm², greater than or equal to 215 mm², or greater than or equal to 220 mm². In another aspect, the opening area A of each exhaust outlet 140 is less than or equal to 250 mm², such as less than or equal to 245 mm², less than or equal to 240 mm², less than or equal to 235 mm², less than or equal to 230 mm², or less than or equal to 225 mm². It is to be understood that the size of the opening area A may be within a range between, and including, each of the minimum and maximum values of the opening area A.

FIG. 5 further illustrates that the random orbit sander 100 includes a vacuum channel 144 along the bottom of the housing 102. The vacuum channel 144 terminates at an enlarged connector 146 that is sized and shaped to connect to a vacuum hose of a remote vacuum source (e.g., a shop vacuum). As shown, a first counterweight 148 and a second counterweight 150 are disposed around the random orbit mechanism 130 to provide a counterbalance for the backing pad 134, which is offset from the motor shaft 122. The random orbit sander 100 further includes a spindle lock assembly 152 between the counterweights 148, 150 and the backing pad 134.

As further illustrated in FIG. 5, the electronic control unit 137 includes a printed circuit board (PCB) 154 within the housing 102 above the motor 120. The PCB 154 extends from the motor housing portion 110 into the handle portion 114. The PCB 154 is substantially perpendicular to the motor axis 112 and substantially parallel to the handle axis 116. The PCB 154 is connected to the motor 120. A mode switch 156 is connected to the PCB 154. In some embodiments, the mode switch 156 is a push-button momentary switch mounted on a separate PCB. The random orbit sander 100 further includes a paddle switch 158 with a paddle 159 adjacent the PCB 154. The switches 156, 158 control the operation of the motor 120 between two modes of operation for the random orbit sander 100.

In a first mode of operation, when the mode switch 156 is pressed and released, the random orbit sander 100 is placed in a standard operating mode. In the standard operating mode, the random orbit sander 100 is on and the motor 120 is controlled by the movement of the paddle 159 on the paddle switch 158, such that as the paddle 159 is pressed the motor 120 rotates at a variable speed corresponding to the depth at which the paddle 159 is pressed. In the standard operating mode, a speed control switch 160, e.g., a potentiometer switch, is rotated to set the maximum operating speed and fully depressing the paddle 159 causes the random orbit sander 100 to operate at the maximum speed set by the speed control switch 160.

In a second mode of operation, while the random orbit sander 100 is on (or in standard operating mode) when the mode switch 156 is pressed and held for a predetermined time period, e.g., five seconds, the random orbit sander 100 enters a lock-on operating mode in which the motor 120 is powered on to rotate without input from the paddle switch 158. In the lock-on operating mode, the speed control switch 160 is rotated to control the speed at which the motor 120 rotates. The lock-on operating mode is exited when the mode switch 156 is once again pressed. In other words, the random orbit sander 100 returns to the standard operating mode. The mode switch 156 is surrounded by an LED indicator 162 that glows a first color, e.g., green, when the random orbit sander 100 is in the standard operating mode of operation. The LED indicator 162 glows a second color, e.g., blue, when the random orbit sander 100 is in the lock-on operating mode of operation. When the random orbit sander 100 is turned off, the LED indicator 162 does not glow any color (i.e., it is off).

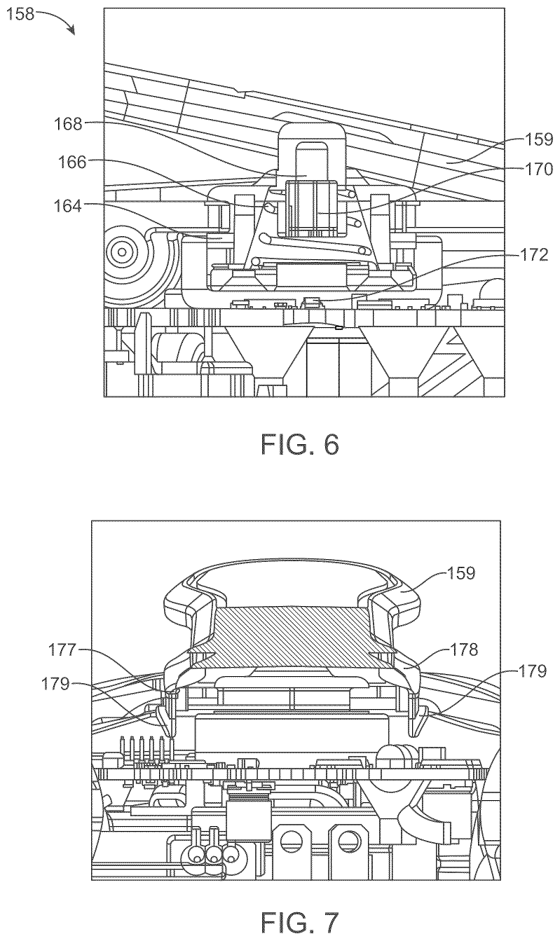

FIGS. 5 and 6 show that the paddle switch 158 is mounted adjacent the PCB 154 and includes a support 164 with a conical spring 166 mounted therein. A foam blocker 167 is disposed between the support 164 and the PCB 154 to prevent ingress onto the PCB 154. An actuator post 168 is installed within the spring 166 and includes a magnet 170 disposed therein (e.g., in an end of the actuator post 168 nearest the PCB 154.) The PCB 154 includes a Hall-effect sensor 172 aligned with the magnet 170. The paddle 159 is rotatably disposed within the housing 102 adjacent the paddle switch 158. As the paddle 159 is pressed, the actuator post 168 moves toward the base of the support 164 and compresses the spring 166. Further, the magnet 170 moves toward the Hall-effect sensor 172. As the distance between the magnet 170 and the Hall-effect sensor 172 changes, the signal output by the Hall-effect sensor 172 also changes. This signal is used to control the speed of the motor 120. For example, as magnet 170 gets closer to the Hall-effect sensor 172, the speed of the motor 120 increases to a maximum speed. Conversely, as the magnet 170 moves away from the Hall-effect sensor 172, the speed of the motor 120 decreases to a zero speed.

In a particular aspect, the magnet 170 moves between a maximum distance Dmax from the Hall-effect sensor 172 to a minimum distance Dmin from the Hall-effect sensor 172. In particular, Dmax is greater than or equal to 5.0 mm, such as greater than or equal to 5.5 mm, greater than or equal to 6.0 mm, greater than or equal to 6.5 mm, greater than or equal to 7.0 mm, or greater than or equal to 7.5 mm. Further, Dmax is less than or equal to 10.0 mm, such as less than or equal to 9.5 mm, less than or equal to 9.0 mm, less than or equal to 8.5 mm, or less than or equal to 8.0 mm. It is to be understood that Dmax may be within a range between and including any of the minimum and maximum values of Dmax disclosed herein. In another aspect, Dmin is less than or equal to 5.0 mm, such as less than or equal to 4.5 mm, less than or equal to 4.0 mm, less than or equal to 3.5 mm, or less than or equal to 3.0 mm. Dmin is greater than or equal to 1.0 mm, such as greater than or equal to 1.5 mm, greater than or equal to 2.0 mm, or greater than or equal to 2.5 mm. Further, it is to be understood that Dmin may be within a range between and including any of the maximum and minimum values of Dmin disclosed herein.

As best illustrated in FIG. 5, the actuator post 168 includes an actuator axis 174 and the paddle 159 includes a pivot axis 176. The pivot axis 176 is perpendicular to the actuator axis 174 and is offset from the actuator axis 174 by an offset distance Do. Moreover, the paddle 159 has a length Lp measured from the pivot axis 176 to the free end of the paddle 159. The paddle 159 also has a travel height Ht measured at the free end of the paddle 159 from the top of the housing 102 to the free end of the paddle 159. In a particular aspect, Do is less than Lp. Further, Ht is less than Do. For example, Do is less than or equal to 0.450 Lp, such as less than or equal to 0.425 Lp, less than or equal to 0.400 Lp, less than or equal to 0.375 Lp, or less than or equal to 0.350 Lp. In another aspect, Do is greater than or equal to 0.250 Lp, such as greater than or equal to 0.275 Lp, or greater than or equal to 0.300 Lp. In another aspect, Do is equal to 0.325 Lp. It is to be understood that Do can be within a range between, and including, any of the maximum and minimum values of Do described herein.

In another aspect, Do is less than or equal to 23.00 mm, such as less than or equal to 22.75 mm, less than or equal to 22.50 mm, less than or equal to 22.25 mm, less than or equal to 22.00 mm, less than or equal to 21.75 mm, less than or equal to 21.50 mm, or less than or equal to 21.25 mm. Do is greater than or equal to 20.00 mm, such as greater than or equal to 20.25 mm, greater than or equal to 20.50 mm, or greater than or equal to 20.75 mm. In another aspect, Do is equal to 21.00 mm. It is to be understood that Do can be within a range between, and including, any of the maximum and minimum values of Do described herein.

In another aspect, Lp is less than or equal to 67.00 mm, such as less than or equal to 66.75 mm, less than or equal to 66.50 mm, less than or equal to 66.25 mm, less than or equal to 66.00 mm, less than or equal to 65.75 mm, less than or equal to 65.50 mm, or less than or equal to 65.25 mm. Lp is greater than or equal to 64.00 mm, such as greater than or equal to 64.25 mm, greater than or equal to 64.50 mm, or greater than or equal to 64.75 mm. In another aspect, Lp is equal to 65.00 mm. It is to be understood that Lp can be within a range between, and including, any of the maximum and minimum values of Lp described herein.

In yet another aspect, Ht is less than or equal to 0.850 Do, such as less than or equal to 0.825 Do, less than or equal to 0.800 Do, less than or equal to 0.775 Do, less than or equal to 0.750 Do, or less than or equal to 0.725 Do. In another aspect, Ht is greater than or equal to 0.650 Do, such as greater than or equal to 0.675 Do, or greater than or equal to 0.700 Do. In another aspect, Do is equal to 0.714 Do. It is to be understood that Ht can be within a range between, and including, any of the maximum and minimum values of Ht described herein.

FIG. 7 shows that the paddle 159 includes two extension arms 177, 178 that allow the paddle 159 to be installed after the housing shells 104, 106 are affixed to each other. The extension arms 177, 178 include wedges 179 that can engage the housing shells 104, 106 to main the paddle 159 in place at the top of the housing 102.

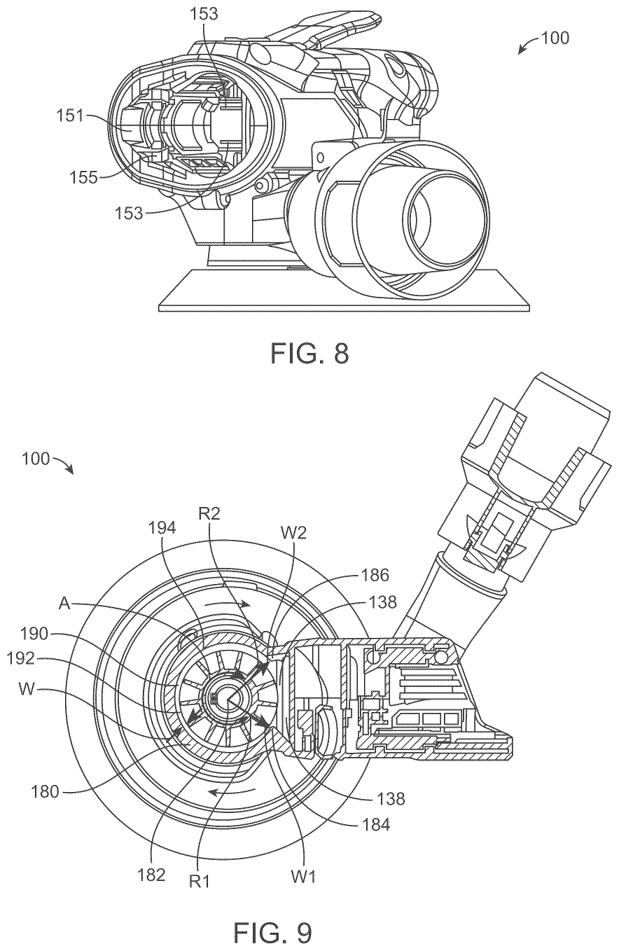

FIG. 8 shows that the battery receptacle 118 is rotated 90 degrees with respect to the housing 102. In other words, a seam 151 along which the shells of the battery receptacle 118 are joined is rotated 90 degrees with respect to the seam 108 (FIG. 1) along which the housing shells 104, 106 are joined. The random orbit sander 100 further includes a pair of elongated battery terminals 153 within the battery receptacle 118 for engaged complementary features on a removable battery. Further, the random orbit sander 100 includes a spring clip that unloads the latches of the removable battery when the battery is in use.

As illustrated in FIG. 9, when the first housing shell 104 is joined with the second housing shell 106, a fan shroud 180 is formed around the fan 136. The fan shroud 180 extends at least partially around the fan 136 over a shroud angle A that is at least 260 degrees. For example, the shroud angle A is greater than or equal to 265 degrees, such as greater than or equal to 270 degrees, greater than or equal to 275 degrees, greater than or equal to 280 degrees, or greater than or equal to 285 degrees. In another aspect, the shroud angle A is less than or equal to 315 degrees, such as less than or equal to 310 degrees, less than or equal to 305 degrees, less than or equal to 300 degrees, less than or equal to 295 degrees, or less than or equal to 290 degrees. It is to be understood that the shroud angle A may be within a range between, and including, any of the minimum and maximum values of the shroud angle A disclosed herein.

The fan shroud 180 includes a variable radius R as measured from a center 182 of the fan 136. The variable radius R continuously increases in the direction of rotation of the fan 136 from a first end 184 of the fan shroud 180 to a second end 186 of the fan shroud 180. Accordingly, the radius R1 at the first end 184 is less than the radius R2 at the second end 186. For example, R1 is less than or equal to 0.975 R2, such as less than or equal to 0.950 R2, less than or equal to 0.925 R2, less than or equal to 0.900 R2, or less than or equal to 0.875 R2. In another aspect, R1 is greater than or equal 0.700 R2, such as greater than or equal 0.725 R2, greater than or equal 0.750 R2, greater than or equal 0.775 R2, greater than or equal 0.800 R2, greater than or equal 0.825 R2, or greater than or equal 0.850 R2. It is to be understood that R1 may be within a range between, and including, any of the maximum and minimum values of R1 disclosed herein.

As further shown in FIG. 9, an air channel 190 is formed around the fan 136 between the outer periphery 192 of the fan 136 and the inner wall 194 of the fan shroud 180. The air channel 190 is in fluid communication with the exhaust ducts 138. As illustrated, the air channel 190 has a variable width W along the length of the air channel 190. Specifically, the width W of the air channel 190 continuously increases in the direction of rotation of the fan 136 from the first end 184 of the fan shroud 180 to the second end 186 of the fan shroud 180. Accordingly, the width W1 at the first end 184 is less than the width W2 at the second end 186. For example, W1 is less than or equal to 0.300 W2, such as less than or equal to 0.275 W2, less than or equal to 0.250 W2, less than or equal to 0.225 W2, or less than or equal to 0.200 W2. In another aspect, W1 is greater than or equal 0.025 W2, such as greater than or equal 0.050 W2, greater than or equal 0.075 W2, greater than or equal 0.100 W2, greater than or equal 0.125 W2, greater than or equal 0.150 W2, or greater than or equal 0.175 W2. It is to be understood that W1 may be within a range between, and including, any of the maximum and minimum values of W1 disclosed herein.

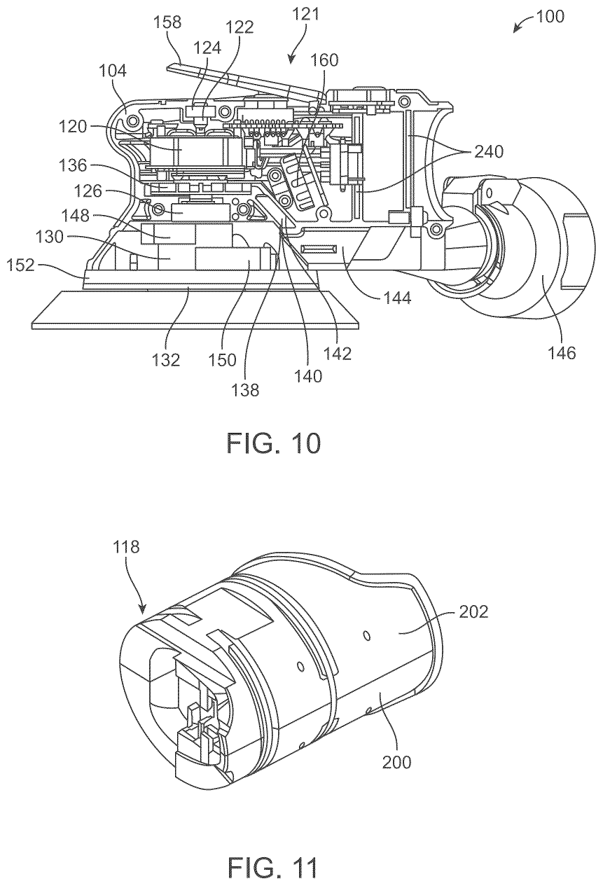

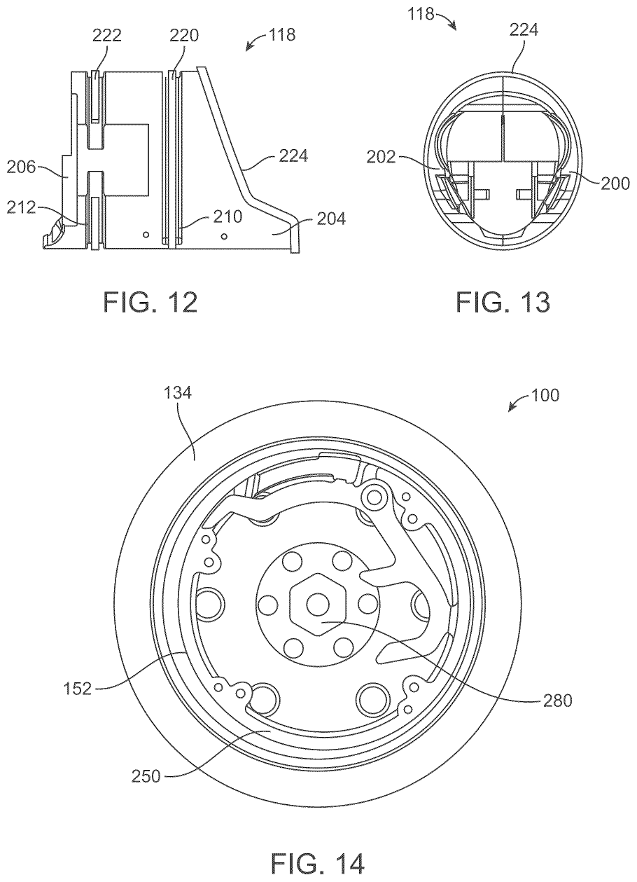

Referring now to FIGS. 11-13, details concerning the battery receptacle 118 are shown. The battery receptacle 118 includes a first receptacle shell 200 coupled to a second receptacle shell 202 to form a generally tubular structure that is sized and shaped to receive the stem of a battery pack. The battery receptacle 118 defines a proximal end 204 and a distal end 206. A first channel 210 extends around the outer periphery of the battery receptacle 118 at a location near a midpoint of the battery receptacle 118. A second channel 212 extends around the outer periphery of the battery receptacle 118 near the distal end 206 of the battery receptacle 118. A first vibration reducing element 220 is disposed in the first channel 210. A second vibration reducing element 222 is disposed in the second channel 212. Further, a third vibration reducing element 224 is disposed on the proximal end 204 of the battery receptacle 118 and follows the contours of the proximal end 204. When the battery receptacle 118 is installed between the first housing shell 104 and the second housing shell 106, the vibration reducing elements 220, 222, 224 prevent direct contact between the outer surface of the battery receptacle 118 and the inner surface of the handle portion 114. Accordingly, during operation of the random orbit sander 100, the vibration reducing elements 220, 222, 224 isolate the battery receptacle 118 and the battery pack disposed therein from vibrations due to the operation of the random orbit sander 100. As such, the transmission of vibration to the battery receptacle 118 is substantially reduced which, in turn, increases the life of the engaged battery pack. Referring briefly to FIG. 10, it is to be understood that the interior of the housing shells 104, 106 may include vibration reducing elements 240 affixed to, or otherwise molded thereon. It is to be understood that the first housing shell 104 is depicted in FIG. 10, but the second housing shell 106 can include similar vibration reducing elements 240.

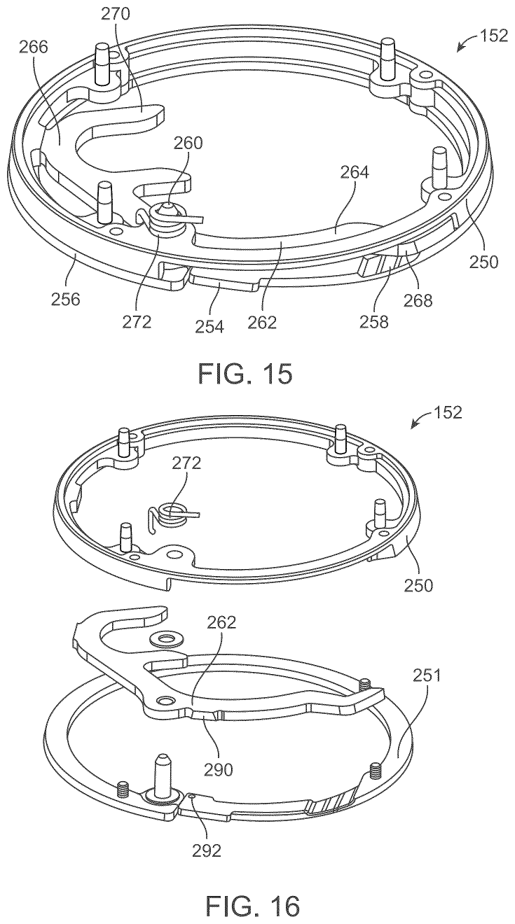

FIGS. 14-19 show the details concerning the spindle lock assembly 152. As illustrated, the spindle lock assembly 152 includes a support ring 250 having a wrench frame 251 affixed thereto. The wrench frame 251 is formed with a split 252. As such, the wrench frame 251 includes a free end 254 and a fixed end 256. The wrench frame 251 is further formed with a necked portion 258 near the free end 254 to allow the free end 254 to flex upward and downward relative to the fixed end 256. The spindle lock assembly 152 further includes a pivot 260 on which a wrench 262 is rotatably disposed. The wrench 262 includes a proximal end 264 and a distal end 266. The proximal end 264 of the wrench 262 includes a handle 268 and the distal end of the wrench 262 includes a wrench head 270. The spindle lock assembly 152 further includes a spring 272 that biases the wrench 262 toward the center of the wrench frame 251 when the free end 254 of the wrench frame 251 is biased in a downward direction.

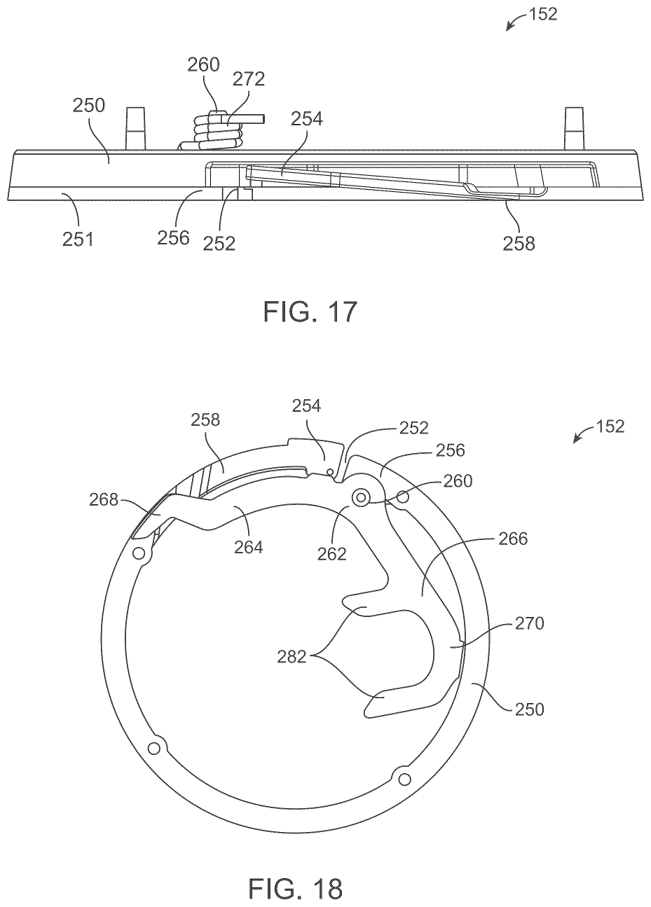

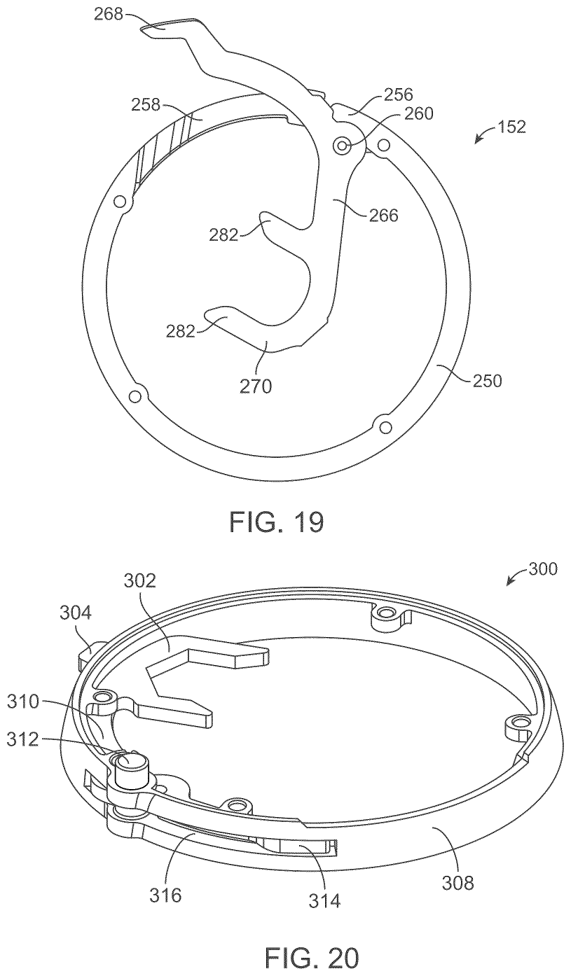

During operation, to lock the output shaft 132 of the random orbit mechanism 130, the free end 254 of the wrench frame 251 is pushed in a downward direction relative to the spindle lock assembly 152, the spring 272 biases the wrench 262 outward slightly to allow the handle 268 of the wrench 262 to be retrieved and pulled radially outward relative to the wrench frame 251. This movement causes the wrench 262 to rotate on the pivot 260 to a deployed position, or lock position, so that the wrench head 270 moves toward a center of the random orbit sander 100 to engage an attachment nut 280 (FIG. 14) disposed on the output shaft 132 of the random orbit mechanism 130. As shown in FIGS. 18 and 19, jaws 282 defining the wrench head 270 are rounded to facilitate the wrench 262 sliding over the attachment nut 280 if the jaws 282 are not perfectly aligned with parallel flats of the attachment nut 280. In the stowed position of the wrench 262, shown in FIG. 17, the free end 254 of the wrench frame 251 may bias the handle 268 of the wrench 262 in an upward direction, which (slightly) tilts the wrench 262 so that the wrench head 270 is tilted in a downward direction and the wrench head 270 is safely parked away from the nearest counterweight 150. In the stowed position, the wrench frame 251 interfaces with a ramped surface 290 formed on the wrench 262 where the free end 254 of the wrench frame 251 contacts the wrench 262 to allow zero movement of the wrench 262 in the stowed position. This substantially minimizes vibration of the spindle lock assembly 152 (specifically, the wrench 262) during use of the random orbit sander 100. The free end 254 of the wrench frame 251 further includes a detent ball 292 that fits into a detent hole formed in a lower surface of the support ring 250 adjacent the free end 254 of the wrench frame 251 when the spindle lock assembly 152 is in the stowed position.

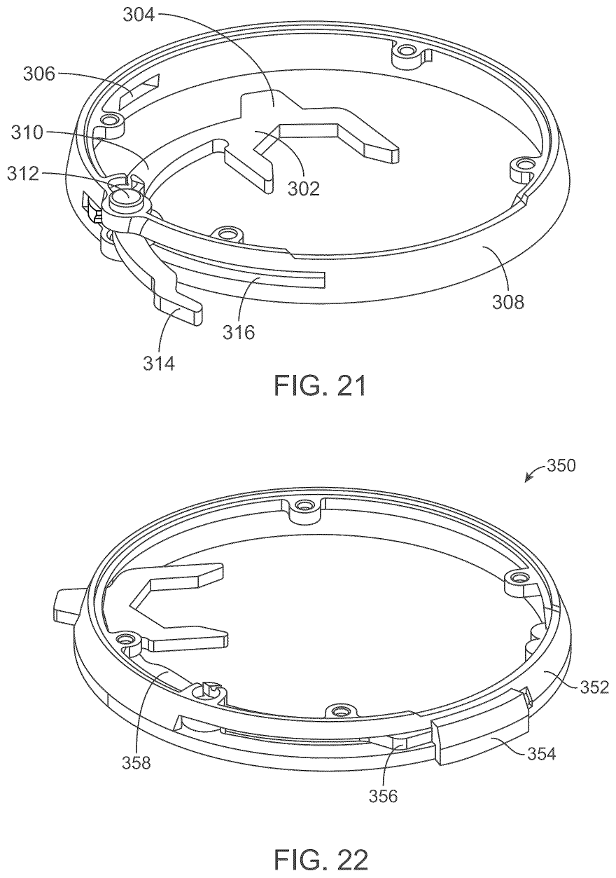

FIGS. 20 and 21 illustrate another embodiment of a spindle lock assembly 300 in which a wrench head 302 includes a protrusion 304 that extends through a first slot 306 formed in the support ring 308. A user can push the protrusion 304 to rotate the wrench 310 on a pivot when a lock button 312 is pressed so that a handle 314 of wrench 310 extends through a second slot 316 formed in the support ring 308, thereby making the handle 314 accessible to the user to pull and rotate the wrench head 302 into engagement with the attachment nut 280.

In another embodiment of a spindle lock assembly 350, shown in FIG. 22, the support ring 352 includes a slide lock 354 to prevent the handle 356 from prematurely extending through a slot in the support ring 352. To release the wrench 358, the slide lock 354 is moved away from the handle 356 to allow the wrench 358 to rotate within the support ring 352.

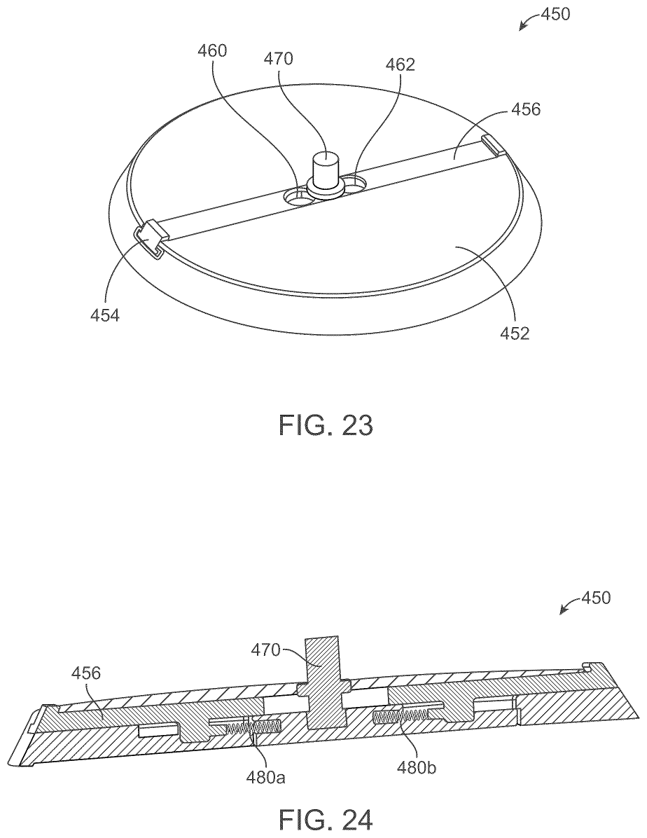

Referring now to FIGS. 23-27, an embodiment of a backing pad 450 is shown that is alternately attachable to the output shaft of a random orbit tool. For example, the backing pad 450 may be attached to the output shaft 132 of the random orbit mechanism 130. In another aspect, the backing pad 450 may be attached to the output shaft of a random orbit polisher.

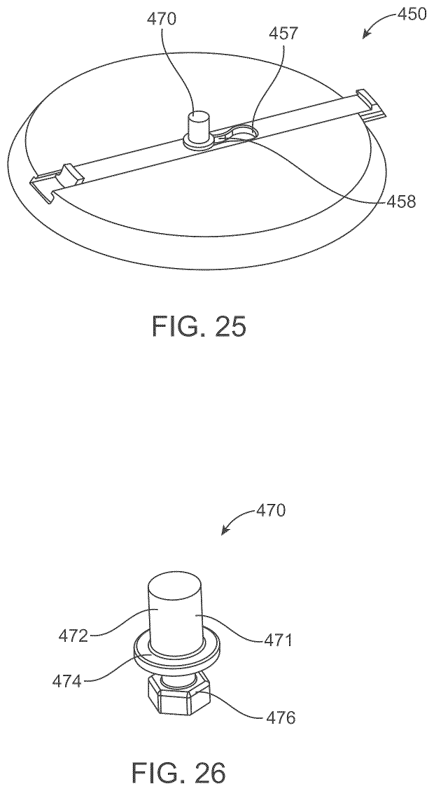

As illustrated, the backing pad 450 includes a body 452 formed with a central slot 454 that extends along the entire diameter of the body 452 through the center of the body 452. An attachment slide 456 is slidably disposed within the slot 454. The attachment slide 456 includes an opening 457 having a central necked portion 458 flanked by a first enlarged portion 460 and a second enlarged portion 462. Each end 464, 466 of the attachment slide 456 is slightly enlarged to provide greater area for a user to press against when sliding the attachment slide 456 within the slot 454. As shown, the backing pad 450 includes a spindle 470 having a generally cylindrical spindle body 471 that includes a threaded portion 472 near a first end of the spindle body 471, a stop plate 474 near a midpoint of the spindle body 471, and a nut 476 at a second end of the spindle body 471 opposite the first end of the spindle body 471. The stop plate 474 is a generally cylindrical disc that extends radially outward from the spindle body 471. Further, the stop plate 474 is configured to abut the attachment slide 456 of the backing pad 450 when the backing pad 450 is disposed on the spindle 470. The backing pad 450 also includes springs 480a, 480b that maintain the attachment slide 456 in a locked position shown in FIG. 23 and that are compressible in response to movement of the attachment slide 456 from the locked position. Specifically, a first spring 480a biases the attachment slide 456 to the locked position in a first direction. A second spring 480b opposite the first spring 480a biases the attachment slide 456 to the locked position in a second direction opposite the first direction. The first spring 480a is compressed when the attachment slide 456 is moved to a first unlocked position, shown in FIG. 25. The second spring 480b is compressed when the attachment slide 456 is moved to a second unlocked position opposite the first unlocked position.

To engage the body 452 of the backing pad 450 with the spindle 470, the attachment slide 456 is moved in either direction along the slot 454, to either the first unlocked position or the second unlocked position to align an enlarged portion 460, 462 of the attachment slide 456 with the center of the body 452. The nut 476 is placed into the enlarged portion 460, 462 until the stop plate 474 engages the surface of the attachment slide 456. Then, the attachment slide 456 is released, permitting the first spring 480a or the second spring 480b to rebound and return the slide 456 to the locked position so that the necked portion 458 of the opening 457 is aligned with the center of the spindle 470. To remove the body 452 of the backing pad 450, this process is reversed. The threaded portion 472 of the spindle 470 is configured to engage threads formed in the output shaft 132 of the random orbit mechanism 130. As such, the spindle 470 remains engaged with the output shaft 132 while the body 452 of the backing pad 450 is removed from the spindle 470 and the output shaft 132. Accordingly, as described herein the attachment slide 456 is movable from an unlocked position in which one of the enlarged portions 460, 462 is aligned with the center of the body 452 and a locked position in which the necked portion 458 is aligned with the center of the body 452. The necked portion 458 is captured between the stop plate 474 and the nut 476 of the spindle 470 in the locked position.

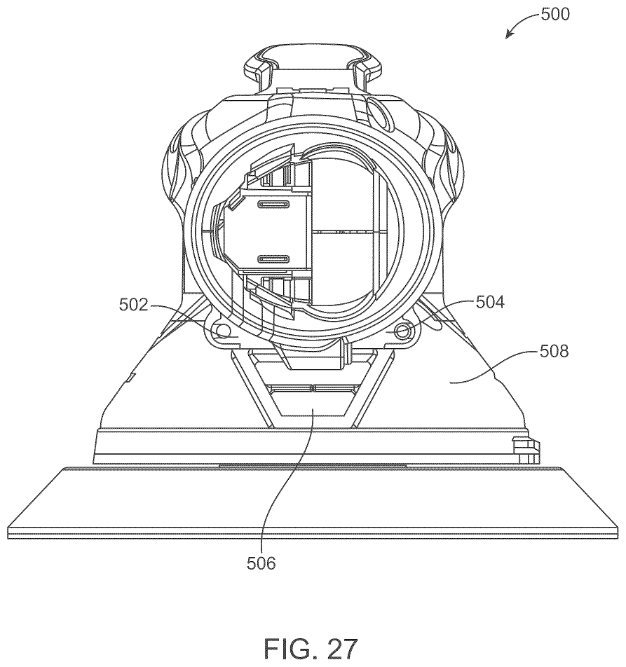

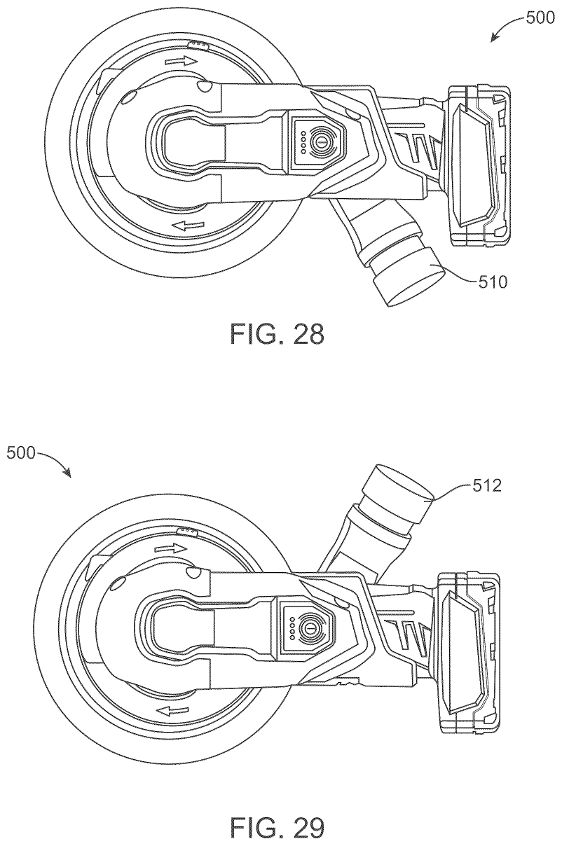

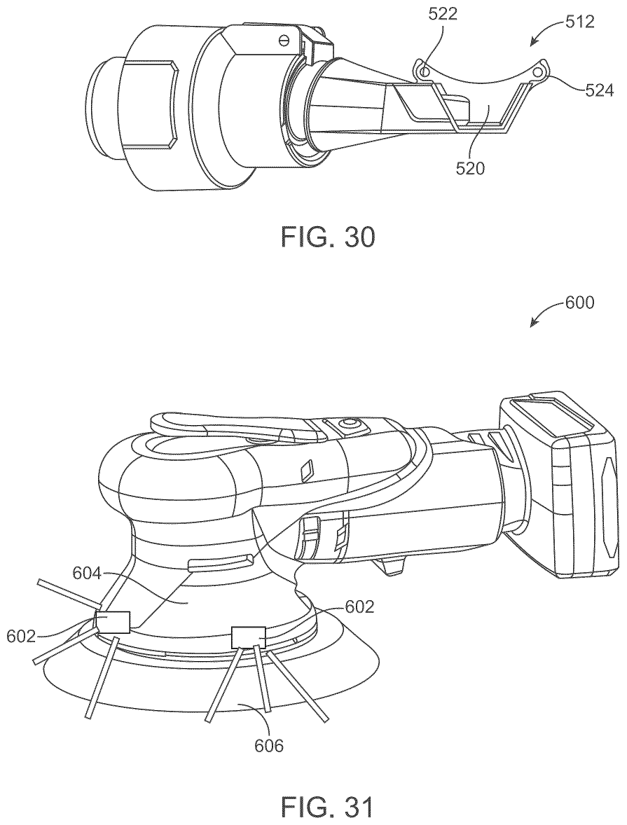

FIG. 27 illustrates an embodiment of a random orbit sander 500 that includes first and second universal vacuum attachment mounts 502, 504 that are adjacent, or flank, a dust outlet 506 formed in the housing 508 of the random orbit sander 500. As shown, first and second universal vacuum attachment mounts 502, 504 are located on opposite sides of the dust outlet 506. The attachment mounts 502, 504 allow a first vacuum attachment 510 to be installed in a leftward direction (FIG. 28) over, or aligned with, the dust outlet 506 or a second vacuum attachment 512 to be installed in a rightward direction (FIG. 29) over, or aligned with, the dust outlet 506. It is to be understood that the second vacuum attachment 512 is a mirror image of the first vacuum attachment 510. Further, as shown in FIG. 30, the second vacuum attachment 512 includes a vacuum port 520 flanked by a first and second attachment tabs 522, 524. The vacuum port 520 fits over the dust outlet 506 and the first and second attachment tabs 522, 524 abut the attachment mounts 502, 504 and threaded fasteners are installed therethrough. It is to be understood that the first vacuum attachment 510 is similarly configured to the second vacuum attachment 512 with a similar vacuum port flanked by attachment tabs.

FIG. 31 illustrates an embodiment of a random orbit sander 600 with a plurality of lights 602 disposed on the motor housing 604 to shine light on a workpiece around the backing pad 606.

Although the invention has been described in detail with reference to certain preferred embodiments, variations and modifications exist within the scope and spirit of one or more independent aspects of the invention as described. Many of the features disclosed herein may be utilized in conjunction with a random orbit tool such as a random orbit sander, a random orbit polisher, or a similar random orbit device.

Various features of the invention are set forth in the following claims.

1. A random orbit sander comprising:
a housing having a motor housing portion and a handle portion extending from the motor housing portion;
a motor disposed within the motor housing portion;
a random orbit mechanism driven by the motor and having an output shaft;
a backing pad removably engaged with the output shaft; and
a spindle lock assembly adjacent the backing pad, wherein the spindle lock assembly includes a support ring and a wrench rotatably disposed on the support ring between a stowed position, in which the wrench is disengaged from a nut on the output shaft, and a deployed position, in which the wrench is engaged with the nut to lock rotation of the output shaft.

2. The random orbit sander of claim 1, wherein the support ring is a split ring with a fixed end and a free end, wherein the free end is movable between a first position, in which the free end maintains the wrench in the stowed position, and a second position, in which the free end allows the wrench to be moved to the deployed position.

3. The random orbit sander of claim 1, wherein the wrench includes a protrusion that extends through the support ring, and wherein the protrusion is accessible from an exterior of the support ring to be pressed to release the wrench from the stowed position.

4. The random orbit sander of claim 3, further comprising a slide lock on the support ring to prevent the wrench from rotating when the protrusion is pressed.

5. The random orbit sander of claim 2, further comprising a spring to bias a handle of the wrench in an outward direction relative to the support ring when the free end of the support ring is moved to the second position.

6. The random orbit sander of claim 1, wherein the backing pad includes:
a body,
a slot formed in the body, and
an attachment slide disposed within the slot and movable between a locked position, in which the body is engaged with the output shaft, and an unlocked position, in which the body is removable from the output shaft.

7. The random orbit sander of claim 6, wherein the backing pad includes a first spring to bias the attachment slide to a locked position in a first direction.

8. The random orbit sander of claim 7, wherein the backing pad includes a second spring to bias the attachment slide to the locked position in a second direction opposite the first direction.

9. The random orbit sander of claim 8, wherein the first spring is compressed when the attachment slide is moved to an unlocked position.

10. The random orbit sander of claim 9, wherein the second spring is compressed when the attachment slide is moved to a second unlocked position opposite the first unlocked position.

11. The random orbit sander of claim 1, further comprising:
a fan configured to rotate with the motor; and
a fan shroud formed around the fan, wherein the fan shroud includes a variable radius R as measured from a center of the fan, wherein the variable radius R changes from a first end of the fan shroud to a second end of the fan shroud.

12. The random orbit sander of claim 11, wherein the variable radius R continuously increases in a direction of rotation of the fan from the first end to the second end.

13. The random orbit sander of claim 12, wherein a radius R1 at the first end of the fan shroud is less than a radius R2 at the second end of the fan shroud.

14. The random orbit sander of claim 13, wherein the radius R1 is less than or equal to 0.975 R2, such as less than or equal to 0.950 R2, less than or equal to 0.925 R2, less than or equal to 0.900 R2, or less than or equal to 0.875 R2.

15. The random orbit sander of claim 14, wherein the radius R1 is greater than or equal 0.700 R2, such as greater than or equal 0.725 R2, greater than or equal 0.750 R2, greater than or equal 0.775 R2, greater than or equal 0.800 R2, greater than or equal 0.825 R2, or greater than or equal 0.850 R2.

16. The random orbit sander of claim 11, further comprising an air channel formed around the fan between an outer periphery of the fan and an inner wall of the fan shroud.

17. The random orbit sander of claim 16, wherein the air channel has a continuously variable width W along a length of the air channel.

18. The random orbit sander of claim 1, further comprising a battery receptacle disposed within the handle portion.

19. The random orbit sander of claim 18, wherein the battery receptacle includes a first receptacle shell coupled to a second receptacle shell to form a generally tubular structure that is sized and shaped to receive a stem of a battery pack.

20. The random orbit sander of claim 19, wherein the battery receptacle includes a first channel around the outer periphery of the battery receptacle, a second channel around the outer periphery of the battery receptacle, a first vibration reducing element disposed in the first channel, and a second vibration reducing element disposed in the second channel.

21.-81. (canceled)
